(19) United States
(12) Patent Application Publication
(10) Pub. No.: US 2015/0146102 A1
(43) Pub. Date: May 28, 2015

(54) METHOD AND DEVICE FOR CONTROLLING CHANNEL-SWITCHING AND NON-TRANSITORY COMPUTER-READABLE STORAGE MEDIUM FOR STORING THE METHOD

(71) Applicant: INSTITUTE FOR INFORMATION INDUSTRY, Taipei (TW)

(72) Inventors: Wen-Shan LIOU, Taipei County (TW); Hsin-I LAI, Taipei City (TW)

(73) Assignee: INSTITUTE FOR INFORMATION INDUSTRY, Taipei (TW)

(21) Appl. No.: 14/203,578

(22) Filed: Mar. 11, 2014

(30) Foreign Application Priority Data
Nov. 28, 2013 (TW) 102143447

(51) Int. Cl. H04N 5/50; H04N 5/445; H04N 21/438; H04N 21/482

(52) U.S. Cl. CPC H04N 5/50; H04N 21/4826; H04N 5/445; H04N 21/4383
USPC 348/570

(57) ABSTRACT

In a method for controlling channel-switching, a current channel is displayed through a display unit. A channel-switching correlation table is looked up to obtain at least one candidate channel, which is predicted to be watched after the current channel. The current channel is switched to the at least one candidate channel when a channel-switching signal is received, such that the display unit displays the at least one candidate channel. The present invention also discloses a device for controlling channel-switching and a non-transitory computer-readable storage medium for storing the method for controlling channel-switching.

### RELATED APPLICATIONS

This application claims priority to Taiwan Application Serial Number 102143447, filed Nov. 28, 2013, which is herein incorporated by reference.

### BACKGROUND

1. Field of Invention

The present invention relates to a method and a device for controlling and a non-transitory computer-readable storage medium for storing the method. More particularly, the present invention relates to a method and a device for controlling channel-switching and a non-transitory computer-readable storage medium for storing the method.

2. Description of Related Art

As technology develops, TVs nowadays are developed with more and more functions, and, as a result, remote controllers are equipped with a lot of buttons for these functions. More and more TV stations are launched, which leads that 3 digits are needed for numbering TV channels. Even if there are several buttons on remote controllers, most users get used to operating up/down or +/− buttons to switch channels in sequence. If numbers of their favorite channels are distributed discretely, users have to operate up/down or +/− buttons for many times to switch to another favorite channel, or they have to remember the number of their favorite channel to input through remote controllers and further press “Enter” or “OK” to confirm to switch.

Generally speaking, most users may watch only some of available channels (for example, less than 10 channels). However, it is not easy for users to remember all of the channel numbers which they are used to watching. “Recall” key can only switch between two channels, such as between a current channel and a previously-watched channel. Yet, switching between two channels cannot satisfy most users' needs.

Above all, there is a need for users to switch to the frequently watched channels without memorizing numbers and with few operation clicks.

### SUMMARY

According to one embodiment of this invention, a method for controlling channel-switching is provided to predict a next channel to be switched to according to a current channel. The method for controlling channel-switching includes the following steps:

(a) a current channel is displayed through a display unit;

(b) a channel-switching correlation table is looked up to obtain at least one candidate channel, which is predicted to be watched after the current channel; and

(c) the current channel is switched to the at least one candidate channel through the data transmission unit when a channel-switching signal is received, such that the display unit displays the at least one candidate channel.

According to another embodiment of this invention, a non-transitory computer-readable storage medium storing a computer program for executing the steps of the aforementioned method for controlling channel-switching is provided. Steps of the method are as disclosed above.

According to another embodiment of this invention, a device for controlling channel-switching is provided. The device for controlling channel-switching includes a data transmission unit, a storage unit and a processing unit. The data transmission unit builds a connection with a display unit. The storage unit stores several instructions and a channel-switching correlation table. The processing unit is electrically connected with the data transmission unit and the storage unit. The instructions stored in the storage unit are operable to cause the processing unit to execute the following steps. The processing unit drives the display unit to display a current channel through the data transmission unit. The processing unit looks up the channel-switching correlation table to obtain at least one candidate channel, which is predicted to be watched after the current channel. The processing unit switches the current channel to the at least one candidate channel through the data transmission unit when a channel-switching signal is received, such that the display unit displays the at least one candidate channel.

These and other features, aspects, and advantages of the present invention will become better understood with reference to the following description and appended claims.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a flow diagram of a method for controlling channel-switching according to one embodiment of this invention;

FIG. 2 illustrates an embodiment of the channel-switching correlation table;

FIG. 3 illustrates an embodiment of a scenario for applying a method for controlling channel-switching of the present invention; and

FIG. 4 illustrates a block diagram of a device for controlling channel-switching according to one embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

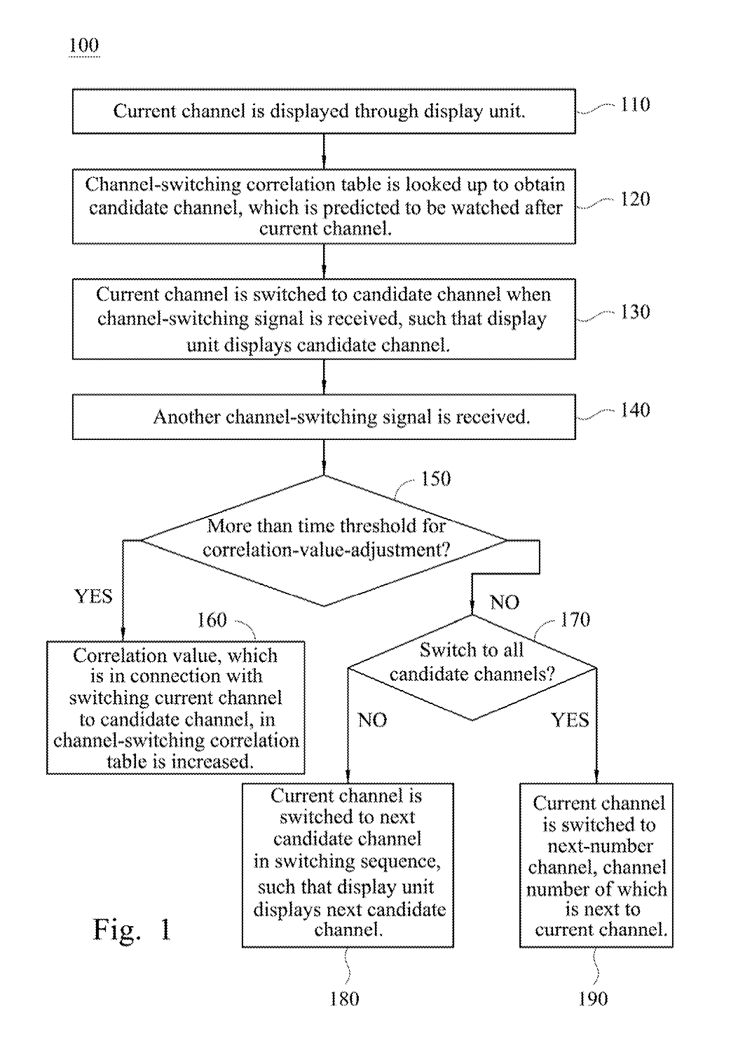

Referring to FIG. 1, a flow diagram will be described that illustrates a method for controlling channel-switching according to one embodiment of this invention. In the method for controlling channel-switching, a next channel to be switched to is predicted according to a current channel. The method for controlling channel-switching may take the form of a computer program product (for example, an APP) stored on a non-transitory computer-readable storage medium having computer-readable instructions embodied in the medium. Any suitable storage medium may be used including non-volatile memory such as read only memory (ROM), programmable read only memory (PROM), erasable programmable read only memory (EPROM), and electrically erasable programmable read only memory (EEPROM) devices; volatile memory such as static random access memory (SRAM), dynamic random access memory (DRAM), and double data rate random access memory (DDR-RAM); optical storage devices such as compact disc read only memories (CD-ROMs), digital versatile disc read only memories (DVD-ROMs), and Blu-ray Disc read only memories (BD-ROMs); magnetic storage devices such as hard disk drives (HDDs); and solid-state disks (SSDs).

The method 100 for controlling channel-switching includes the following steps:

At step 110, a current channel is displayed through a display unit. In some embodiments of this invention, when the display unit has displayed a channel for more than a time threshold for setting-current-channel, the displayed channel is set as the current channel.

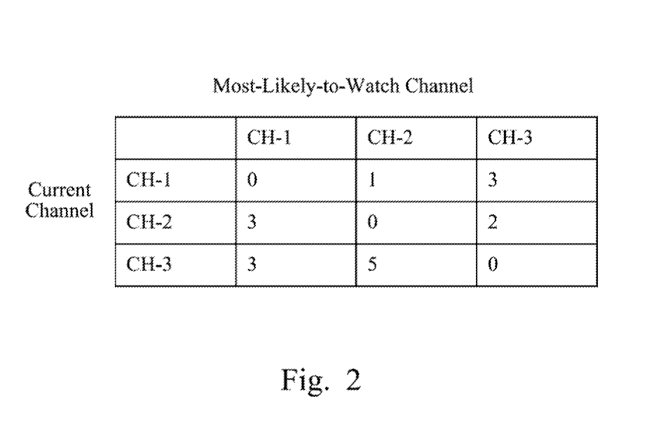

At step 120, a channel-switching correlation table is looked up to obtain at least one candidate channel, which is predicted to be watched after the current channel. In some embodiments, such candidate channel would be the one, which a user is most likely to or frequently watch after the current channel. Referring to FIG. 2, an embodiment of the channel-switching correlation table is illustrated. In this embodiment, the channel-switching correlation table stores correlation values, which are in connection with switching one channel to another candidate channel, which a user is most likely to or frequently watch next. For example, when the current channel is CH-1, the highest correlation value is in connection with switching to CH-3, and, as a result, CH-3 can be taken as a candidate channel, which is predicted to be watched after the current channel. Then, the information of the candidate channel CH-3 is obtained at step 120. In some embodiments of this invention, the correlation values in the channel-switching correlation table may be accumulated number, accumulated time or any other accumulated value in connection with switching one channel to another channel. In addition, if there are several candidate channels having the same correlation value, the difference of the channel number between the current channel and these candidate channels may be taken as a factor for sorting the candidate channels. In some other embodiments of this invention, the time that correlation values were increased may be taken as a factor for sorting the candidate channels.

At step 130, the current channel is switched to the at least one candidate channel when a channel-switching signal is received, such that the display unit displays the at least one candidate channel. The channel-switching signal is generated by a remote controller operated by a user. For example, a user can operate +, −, up, down or any other button for switching to a next channel to generate the channel-switching signal. Therefore, a user can operate a remote controller as usual, and he/she can enjoy the channel-switching function provided by this invention. In some embodiments, the channel-switching signal can be generated by other buttons of a remote controller or generated by other types of operating interfaces, which should not be limited by this disclosure. In addition, the candidate channel is predicted according to the current channel displayed on the display unit, which leads that the predicted candidate channel fits the user's habit after watching the current channel. Therefore, a user can switch to his/her frequently watched channels without remembering channel numbers and with few operation clicks.

In some embodiments of this invention, step 120 can be performed when the current channel is switched to or the channel-switching signal is received to switch the current channel to another channel, which should not be limited in this disclosure.

In some other embodiments of this invention, more than one candidate channels, which are predicted to be watched after the current channel, can be obtained at step 120, and these candidate channels may form a switching sequence. Hence, when another channel-switching signal is received (step 140), step 150 may be performed to determine if the current channel has been switched for more than a time threshold for correlation-value-adjustment. At step 180, when another channel-switching signal is received at the time that the current channel has not been switched for more than the time threshold for correlation-value-adjustment, the current channel is switched to the next candidate channel in the switching sequence, such that the display unit displays the next candidate channel in the switching sequence. Therefore, the display unit can display the candidate channels, which are predicted to be watched after the current channel, respectively, which fits the user's habit.

In addition, step 170 may be performed to determine if all of the candidate channels have been switched to. When not all of the candidate channels have been switched to, it is switched to the next candidate channel in the switching sequence (step 180). At step 190, when all of the candidate channels have been switched to, the current channel is switched to a next-number channel, a channel number of which is next to the current channel, such that the display unit displays the next-number channel. Therefore, even if the user does not want to watch the predicted candidate channels, channels can still be switched according to the channel number.

In some other embodiments of this invention, at step 160, when the current channel has been switched to the candidate channel for more than the time threshold for correlation-value-adjustment, a correlation value, which is in connection with switching the current channel to the candidate channel, in the channel-switching correlation table is increased (for example, a reference value is added to this correlation value.) Therefore, the candidate channel can be predicted precisely. In addition, in some other embodiments of this invention, if the candidate channel is switched to another channel without being watched for more than the time threshold for correlation-value-adjustment, the correlation value, which is in connection with switching the current channel to the candidate channel, in the channel-switching correlation table may be reduced. In some other embodiments of this invention, different time thresholds may be provided to be a factor to increase or reduce correlation values, which should not be limited in this disclosure. Therefore, even if a user just switches through many channels quickly, their correlation values would be reduced to prevent from taking these channels as candidate channels. In some other embodiments of this invention, the current channel is switched to a channel other than the candidate channels, correlation value of the channel other than the candidate channels can also be adjusted according to the total time that the user watch it.

In some other embodiments of the method 100 for controlling channel-switching, the channel-switching correlation table may be updated every preset time interval. For example, the correlation values may be multiplied by a value between 0-1 to reduce the effect of the previous switches. Therefore, the predicted candidate channels can fit the user's watching habit lately.

In some other embodiments of the method 100 for controlling channel-switching, when a channel switching signal generated by another button is received, the current channel may be switched to the channel, which has been watched after power-on. In some embodiments of this invention, buttons “+”, “−” may be set to switch to candidate channels and switch to the channels, which have been watched after power-on. In some other embodiments of this invention, buttons “up”, “down” may be set to switch to candidate channels and switch to the channels, which have been watched after power-on. In some other embodiments of this invention, any two buttons on a remote controller can be set to switch to candidate channels and switch to the channels, which have been watched after power-on.

In some other embodiments of the method 100 for controlling channel-switching, when the display unit have displayed a channel for more than a time threshold for setting-current-channel, the displayed channel (which may be a candidate channel or any other channel selected by other methods) is set as the current channel, and step 120 may be re-performed to obtain at least one candidate channel, which is predicted to be watched after the current channel.

In some embodiments of step 120, different channel-switching correlation tables may be provided for different parameters, such as different periods of time (for example, morning, afternoon or night), identification information of a current user in front of the display unit, or any other parameter for selecting a suitable channel-switching correlation table.

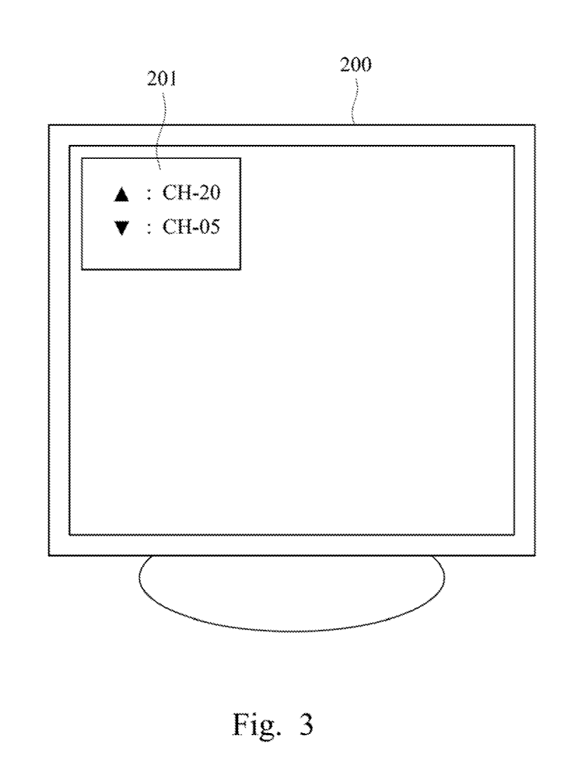

Referring to FIG. 3, an embodiment of a scenario for applying a method for controlling channel-switching of the present invention is illustrated. When the display unit 200 displays a current channel, a preset block 201 of the display unit 200 may be utilized to display information of the candidate channels, such as the channel numbers of the candidate channels. In addition, in other embodiments of this invention, Electronic program guides (EPG) can be utilized to provide information of current programs on the candidate channels, frames of current programs on the candidate channels or any other channel information. Therefore, with above mentioned information, a user can switch to channels he/she wants to watch easily.

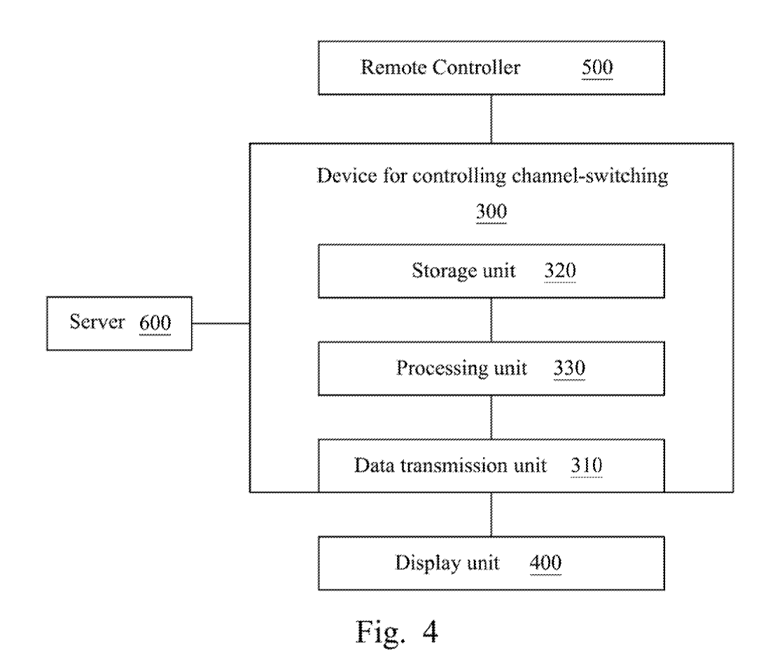

Referring to FIG. 4, a block diagram will be described that illustrates a device for controlling channel-switching according to one embodiment of this invention. The device 300 for controlling channel-switching includes a data transmission unit 310, a storage unit 320 and a processing unit 330. The data transmission unit 310 builds a connection with a display unit 400. The processing unit 330 is electrically connected with the data transmission unit 310 and the storage unit 320.

In some embodiments of this invention, a remote controller 500 and the device 300 for controlling channel-switching are integrated to a single device. In some other embodiments, the device 300 for controlling channel-switching can be integrated to a TV Set-Top box or a TV. In some other embodiments, the device 300 for controlling channel-switching may be a single device, and may build a connection with the remote controller 500 and a TV Set-Top box/TV through a wired or wireless data transmission interface.

The storage unit 320 may be a read-only memory (ROM), a flash memory, a soft disk drive (S.D.D.), a hard disk drive (H.D.D.), an optical storage device, an USB disk, a database accessible from a network, or any other storage unit. The processing unit 330 may be a central processing unit (CPU), a control unit, a micro-processor or any other hardware for executing instructions.

The storage unit 320 stores several instructions and a channel-switching correlation table. The channel-switching correlation table stores correlation values, which are in connection with switching one channel to another candidate channel.

The instructions stored in the storage unit 320 are operable to cause the processing unit 330 to execute the following steps. The processing unit 330 drives the display unit 400 to display a current channel through the data transmission unit 310. In some embodiment of this invention, if the remote controller 500 and the device 300 for controlling channel-switching are integrated to a single device, the remote controller 500 may transmit a signal, which corresponds to a button, to a TV Set-Top box or a TV, such that the display unit 400 corresponding to the TV Set-Top box or the TV displays the current channel. In another embodiment of this invention, if the device 300 for controlling channel-switching is integrated to a TV Set-Top box or a TV, the device 300 for controlling channel-switching may receive a signal, which corresponds to a button, from the remote controller 500, and then the device 300 for controlling channel-switching may drive the display unit 400 to display the current channel corresponding to the signal.

The processing unit 330 looks up the channel-switching correlation table stored in the storage unit 320 to obtain at least one candidate channel, which is predicted to be watched after the current channel. In some embodiments, such candidate channel would be the one, which a user is most likely to or frequently watch after the current channel. In addition, the processing unit 330 may look up different channel-switching correlation tables according to different parameters. The parameter may include periods of time (for example, morning, afternoon or night), identification information of a current user in front of the display unit 400, or any other parameter for selecting a suitable channel-switching correlation table.

When a user operates the remote controller 500 to perform channel-switching, the remote controller 500 may generate a corresponding channel-switching signal. For example, a user can operate +, −, up, down or any other button for switching to a next channel to generate the channel-switching signal. Therefore, a user can operate the remote controller 500 as usual, and he/she can enjoy the channel-switching function provided by this invention. In some embodiments, the channel-switching signal can be generated by other buttons of the remote controller 500 or generated by other types of operating interfaces, which should not be limited by this disclosure. Hence, when a channel-switching signal is received from the remote controller 500, the processing unit 330 switches the current channel to the at least one candidate channel through the data transmission unit 310, such that the display unit 400 displays the at least one candidate channel. In addition, the candidate channel is predicted according to the current channel displayed on the display unit 400, which leads that the predicted candidate channel fits the user's habit after watching the current channel. Therefore, a user can switch to his/her favorite channels without remembering channel numbers and with few operation clicks.

In some embodiments of this invention, the processing unit 330 may obtain more than one candidate channels, which are predicted to be watched after the current channel, and these candidate channels may form a switching sequence. Hence, the storage unit 320 further stores instructions operable to cause the processing unit 330 to switch to the next candidate channel in the switching sequence for the display unit 400 to display when another channel-switching signal is received from the remote controller 500 at the time that the current channel has not been switched for more than a time threshold for correlation-value-adjustment. Therefore, the display unit 400 can display the candidate channels, which are predicted to be watched after the current channel, respectively, which fits the user's habit.

In addition, when all of the candidate channels have been switched to, the processing unit 300 can still switched to a next-number channel, a channel number of which is next to the current channel, for the display unit 400 to display. Therefore, even if the user does not want to watch the predicted candidate channels, channels can still be switched according to the channel number.

In some other embodiments of this invention, when the current channel has been switched to the candidate channel for more than the time threshold for correlation-value-adjustment, the processing unit 330 may increase a correlation value, which is in connection with switching the current channel to the candidate channel, in the channel-switching correlation table. In some embodiments of this invention, the processing unit 330 may increase the correlation value immediately. In some other embodiment of this invention, the processing unit 330 may upload an instruction for increasing the correlation value to a server 600 to update the channel-switching correlation table stored in the server 600. The processing unit 300 may periodically download the channel-switching correlation table stored in the server 600 to update the channel-switching correlation table stored in the storage unit 320. In some other embodiments of this invention, if the candidate channel is switched to another channel without being watched for more than the time threshold for correlation-value-adjustment, the processing unit 330 may reduce the correlation value, which is in connection with switching the current channel to the candidate channel, in the channel-switching correlation table in the storage unit 320. Therefore, even if a user just switches through many channels quickly, their correlation values would be reduced to prevent from taking these channels as candidate channels.

In some other embodiments, the processing unit 330 may update the channel-switching correlation table stored in the storage unit 320 or the server 600 every preset time interval. For example, the processing unit 330 may multiply the correlation values in the channel-switching correlation table to a value between 0-1 to reduce the effect of the previous switches. Therefore, the predicted candidate channels can fit the user's watching habit lately.

In some other embodiments, when a channel switching signal generated by another button of the remote controller 500 is received, the processing unit 330 may switch the current channel to the channel, which has been watched after power-on. In some embodiments of this invention, buttons “+”, “−” on the remote controller 500 may be set to switch to candidate channels and switch to the channels, which have been watched after power-on. In some other embodiments of this invention, buttons “up”, “down” on the remote controller 500 may be set to switch to candidate channels and switch to the channels, which have been watched after power-on. In some other embodiments of this invention, any two buttons on the remote controller 500 can be set to switch to candidate channels and switch to the channels, which have been watched after power-on.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for controlling channel-switching, comprising:
(a) displaying a current channel through a display unit;
(b) looking up a channel-switching correlation table to obtain at least one candidate channel, which is predicted to be watched after the current channel; and
(c) switching the current channel to the at least one candidate channel when a channel-switching signal is received, such that the display unit displays the at least one candidate channel.

2. The method for controlling channel-switching of claim 1, wherein a number of the at least one candidate channel, which is predicted to be watched after the current channel, is more than one, the candidate channels form a switching sequence, the method for controlling channel-switching further comprises:
switching to the next candidate channel in the switching sequence when another channel-switching signal is received at a time that the current channel has not been switched for more than a time threshold for correlation-value-adjustment, such that the display unit displays the next candidate channel in the switching sequence.

3. The method for controlling channel-switching of claim 2, further comprising:
switching to a next-number channel, a channel number of which is next to the current channel, when all of the candidate channels have been switched to, such that the display unit displays the next-number channel.

4. The method for controlling channel-switching of claim 1, further comprising:
increasing a correlation value, which is in connection with switching the current channel to the candidate channel, in the channel-switching correlation table when the current channel has been switched to the candidate channel for more than a time threshold for correlation-value-adjustment.

5. The method for controlling channel-switching of claim 1, further comprising:
updating the channel-switching correlation table every preset time interval.

6. A device for controlling channel-switching, comprising:
a data transmission unit configured to build a connection with a display unit;
a storage unit, wherein the storage unit stores a plurality of instructions and a channel-switching correlation table; and
a processing unit electrically connected with the data transmission unit and the storage unit, wherein the instructions stored in the storage unit are operable to cause the processing unit to:
(a) drive the display unit to display a current channel through the data transmission unit;
(b) look up the channel-switching correlation table to obtain at least one candidate channel, which is predicted to be watched after the current channel; and
(c) switch the current channel to the at least one candidate channel through the data transmission unit when a channel-switching signal is received, such that the display unit displays the at least one candidate channel.

7. The device for controlling channel-switching of claim 6, wherein a number of the at least one candidate channel, which is predicted to be watched after the current channel, is more than one, the candidate channels form a switching sequence, and the storage unit further stores instructions operable to cause the processing unit to:
switch to the next candidate channel in the switching sequence when another channel-switching signal is received at a time that the current channel has not been switched for more than a time threshold for correlation-value-adjustment, such that the display unit displays the next candidate channel in the switching sequence.

8. The device for controlling channel-switching of claim 7, wherein the storage unit further stores instructions operable to cause the processing unit to:
switch to a next-number channel, a channel number of which is next to the current channel, when all of the candidate channels have been switched to, such that the display unit displays the next-number channel.

9. The device for controlling channel-switching of claim 6, wherein the storage unit further stores instructions operable to cause the processing unit to:
increase a correlation value, which is in connection with switching the current channel to the candidate channel, in the channel-switching correlation table when the current channel has been switched to the candidate channel for more than a time threshold for correlation-value-adjustment.

10. The device for controlling channel-switching of claim 6, wherein the storage unit further stores instructions operable to cause the processing unit to:
update the channel-switching correlation table every preset time interval.

11. A non-transitory computer-readable storage medium that stores a program which causes a computer to execute a method for controlling channel-switching, wherein the method for controlling channel-switching comprises:
(a) displaying a current channel through a display unit;
(b) looking up a channel-switching correlation table to obtain at least one candidate channel, which is predicted to be watched after the current channel; and
(c) switching the current channel to the at least one candidate channel when a channel-switching signal is received, such that the display unit displays the at least one candidate channel.
